(19) United States
(12) Patent Application Publication
(10) Pub. No.: US 2004/0122841 A1
(43) Pub. Date: Jun. 24, 2004

(54) METHOD AND SYSTEM FOR EVALUATING INTELLECTUAL PROPERTY

(75) Inventors: Bryan Roger Goodman, Dearborn, MI (US); Bardia Madani, West Bloomfield, MI (US); Carol Beckman, Swarthmore, PA (US); Damian Porcari, Farmington Hills, MI (US); Nancy Ann Fricano, Roseville, MI (US); Paul Marshall Stieg, Farmington Hills, MI (US); Robert Nathan Schwarzwalder JR., Ann Arbor, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD MOTOR COMPANY, Dearborn, MI (US)

(21) Appl. No.: 10/248,127

(22) Filed: Dec. 19, 2002

(51) Int. Cl. G06F 17/00; G06F 7/00

(52) U.S. Cl. 707/102

(57) ABSTRACT

One aspect of the present invention includes a computer-implemented method for evaluating intellectual property. One preferred computer-implemented method includes obtaining a plurality of intellectual property (IP) records, preparing an IP data set based on the plurality of IP records, analyzing the IP data set to obtain an at least one IP cluster, and displaying the at least one IP cluster to allow a user to evaluate IP opportunities for the IP data set. IP opportunities include, but are not limited to, licensing, donation, infringement, and competitive intelligence opportunities.

### BACKGROUND OF THE INVENTION

1. Field of the Invention

One aspect of the present invention generally relates to a method and system for evaluating intellectual property and, more specifically, relates to a method and system for evaluating the licensing, donating, infringement, and/or competitive intelligence opportunities related to intellectual property.

2. Background Art

In today's global economy, intellectual property (otherwise referred to as IP), and specifically patents are very important to a company's business success for a multitude of reasons.

For instance, a company has the right to exclude competitors from making, using, and selling their patented technology. In the case of patented technology embodied in a company's products or services, i.e., core technology, this right to exclude is vital to staving off competitors.

Patents can also represent a sizable and increasing revenue stream for companies. For example, in 1 993, U.S. companies generated over $60 billion in revenue from patents. Fred Warshofsky, The Patent Wars, John Wiley & Sons, Inc., New York, 1 994. From the years of 1990 to 2000, the annual patent licensing royalties at IBM grew from $30 million to $1 billion. Kevin Rivette, Discovering New Value in Intellectual Property, Jan. 1, 2000 Harv. Bus. Rev. 54.

Patents can also be used as donations to universities and nonprofit organizations, aiding universities and nonprofit organizations in the further development of technology. In one year alone, Dow saved approximately $50 million in taxes and maintenance fees by donating nonessential patents to universities and nonprofit organizations.

Some companies have recognized the vital importance of patents to their business. Consequently, these businesses have turned to systems to manage their patent portfolios. However, these systems offer limited functionality. Additionally, grouping patents based on subject matter is primarily accomplished through searching patent search classes (i.e., international search classes).

Overall, most patent portfolio evaluation methods and systems have focused on monetary evaluation of a single patent and not on identification of potential licensing and/or donation candidates.

Other systems have been proposed that accommodate multiple patents with limited functionality. For example, U.S. Pat. No. 5,991,751, assigned to SmartPatents, Inc., proposes a system for data processing of patents, and allows for non-patent data (i.e., licensing and manufacturing information). Patents are stored as patent records and non-patent data linked with a database management system (DBMS), as opposed to being part of the patent record. Additionally, identifying patterns and associations located within a patent portfolio evaluation functionality is limited to standard analysis typical of a traditional DBMS. In addition, although patents may be evaluated in groupings based on citation connection, author, or keyword, patents cannot be grouped by data visualization techniques.

As another example, WO 00/52618, assigned to Aurigin Systems, Inc., proposes a system for linking non-patent information in a DBMS. This system suffers from the disadvantage of offering limited analysis functionality typical of a traditional DBMS. Moreover, data visualization is only available through means of hyperbolic trees.

Another system has been proposed to identify patents for potential licensing based on another company's patent citations. The Patent Cousins software application, available from the Metrics Group of Falls Church, Virginia, includes the ability to determine a group of related patents from a single company by identifying two patents from company A that are cited by a single patent from company B. However, this application is limited to identifying pairs and is, therefore, not very useful for identification of patents for potential licensing.

Manual methods of mapping patents have also been proposed. For example, a method has been proposed to manually map patents by usage and corporate sub-organization. Kevin Rivette, Discovering New Value in Intellectual Property, Jan 1, 2000 Harv. Bus. Rev. 54. However, this method is not computer-implemented and does not present an overall computer-implemented strategy managing a patent portfolio.

What is needed is a method and system evaluating intellectual property, not only patents. This computer-implemented method and system should be able to evaluate IP opportunities in terms of licensing, donating, infringement, and/or competitive intelligence. This computer-implemented method and system should offer an overall analysis solution that utilizes IP clustering, i.e., data mining, data visualization, and/or data clustering, to cluster IP technology for use in evaluating IP opportunities. By using IP clustering, this method and system should be able to link IP records together by the text comprising the IP records.

### SUMMARY OF INVENTION

One aspect of the present invention is a computer-implemented method and system for evaluating intellectual property. Another aspect of the present invention is a computer-implemented method and system that can evaluate IP opportunities in terms of licensing, donating, infringement, and/or competitive intelligence. Yet another aspect of the present invention is a computer-implemented method and system that can evaluate IP opportunities by using IP clustering, for example, data mining, data visualization, and/or data clustering, to cluster IP technology. Another aspect of the present invention is the ability to link IP records based on the text comprising the IP records.

One preferred computer-implemented method embodiment of the present invention for evaluating intellectual property includes obtaining a plurality of intellectual property (IP) records, preparing an IP data set based on the plurality of IP records, analyzing the IP data set to obtain an at least one IP cluster, and displaying the at least one IP cluster to allow a user to evaluate IP opportunities for the IP data set.

In a preferred embodiment, IP records can be comprised of patent records and the IP data set can include at least one non-patent data field for each patent record. IP data sets can be comprised of licensing, donation, infringement, and competitive intelligence data sets, individually or in combination.

One preferred system embodiment of the present invention for evaluating intellectual property includes an at least one computer configured to obtain a plurality of intellectual property records, prepare an IP data set based on the plurality of IP records, analyze the IP data set to obtain an at least one IP cluster, and display the at least one IP cluster to allow a user to evaluate IP opportunities for the IP data set.

In a preferred system embodiment, IP records can be comprised of patent records and the IP data set can include an at least one non-patent data field for each patent record. IP data sets can be comprised of licensing; donation, infringement, and competitive intelligence data sets, individually or in combination.

Another preferred method embodiment of the present invention relates to the identification of a group of related patents for evaluation of licensing opportunities. The method preferably includes providing a first group of patents, collecting a second group of patents citing to at least one patent in the first group, and for each patent member in the second group, if at least two patents cited to by the patent member are included in the first group, adding the at least two patents to a group of related patents. In one preferred embodiment, if at least three patents cited to by the patent member are included in the first group, the at least three patents are added to a group of related patents.

The above and other objects, features, and advantages of the present invention are readily apparent from the following detailed description of the best mode for carrying out the invention when taken in connection with the accompanying drawings.

### BRIEF DESCRIPTION OF DRAWINGS

The features of the present invention which are believed to be novel are set forth with particularity in the appended claims. The present invention, both as to its organization and manner of operation, together with further objects and advantages thereof, may best be understood with reference to the following description, taken in connection with the accompanying drawings which:

FIG. 1 is a schematic diagram illustrating a preferred embodiment of a system for implementing the present invention;

FIG. 2 is a block flow diagram illustrating a preferred methodology for implementing the present invention;

FIG. 3 is an IP cluster map generated by data visualization software from an IP data set for evaluating licensing/infringement opportunities in accordance with one embodiment of the present invention;

FIG. 4 is an IP cluster map generated by data visualization software from an IP data set for evaluating donation opportunities in accordance with one embodiment of the present invention;

FIG. 5 is a block flow diagram illustrating a preferred methodology for evaluating licensing/infringement opportunities;

FIG. 6 is a block flow diagram illustrating a preferred methodology for evaluating donation opportunities; and

FIG. 7 is a block flow diagram illustrating a preferred methodology for evaluating competitive intelligence opportunities.

### DETAILED DESCRIPTION

As required, detailed embodiments of the present invention are disclosed herein. However, it is to be understood that the disclosed embodiments are merely exemplary of the invention that may be embodied in various and alternative forms. Therefore, specific functional details herein are not to be interpreted as limiting, but merely as a representative basis for the claims and/or as a representative basis for teaching one skilled in the art to variously employ the present invention.

One aspect of the present invention relates to a computer-implemented method for evaluating intellectual property (otherwise referred to as IP). The method generally comprises: (1) obtaining a plurality of IP records; (2) preparing an IP data set based on the plurality of IP records; (3) analyzing the IP data set to obtain an at least one IP cluster; and (4) displaying the at least one IP cluster to allow a user to evaluate IP opportunities for the IP data set. It is contemplated that IP opportunities can exist in various different forms, for example, licensing, donation, infringement, and/or competitive intelligence opportunities. Licensing opportunities are evaluated by identifying companies that would be interested in acquiring a license on IP records, i.e., patents. Donation opportunities are evaluated by identifying universities and non-profit organizations that would be interested in acquiring technology for research and development purposes. These may be patents the IP owner previously donated, or third party patents identified as having been donated through an after issue assignment change (e.g., patents originally assigned to an owner with a “company” or “corporation” in their name later assigned to an owner with “university” in their name). Infringement value stems from identifying possible infringers of IP records, i.e., patents. Competitive intelligence opportunities are evaluated by identifying patterns and trends of competitive technology. For example, (1) identification of emerging technologies, (2) strategic patenting (i.e., clustering and/or bracketing), (3) patenting trends (i.e., increased or decreased patenting in a technology field), and (4) technologies that are no longer pursued for patent protection. The above-mentioned method can evaluate intellectual property opportunities in all of these varying forms.

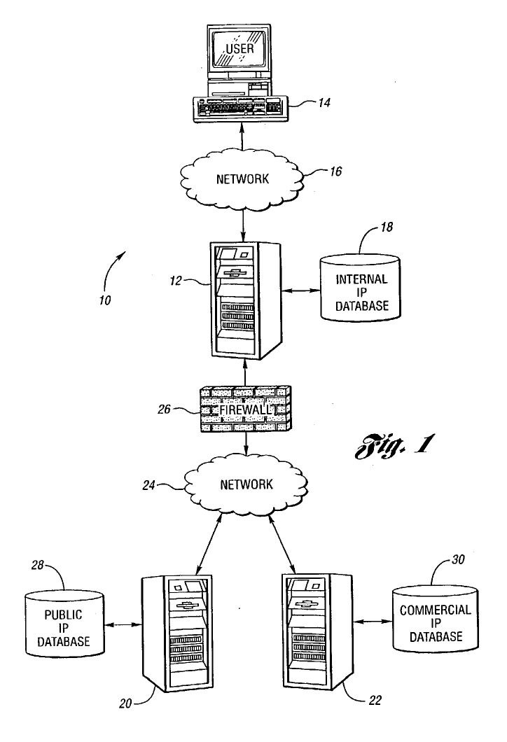

FIG. 1 is a schematic diagram illustrating a preferred system 10 for implementing the present invention, although it should be understood that the methods and systems of the present invention are computer assisted and are not necessarily fully computerized. System 10 comprises at least one internal server computer 12 operably serving at least one user computer 14 through computer network 16. Internal server computer 12 is operably configured to store information to, and retrieve information from, at least one internal IP database 18. It is fully understood that internal server computer 12 can communicate with other databases as well, including, but not limited to, sales, manufacturing, and marketing databases. It is possible to combine server 12 and internal IP database 18 on one computer. In accord with a preferred embodiment of the present invention, internal server computer 12 is operably configured to communicate with at least one public server computer 20 and at least one commercial server computer 22 through network 24 and firewall 26. Public server computer 20 is operably configured to store information to, and retrieve information from, at least one public IP database 28. Commercial server computer 22 is operably configured to store information to, and retrieve information from, at least one commercial IP database 30.

It is fully contemplated that computer networks 16 and 24 can comprise any one or more of a variety of computer communication configurations including but not limited to a local area network (LAN), a wide area network (WAN), a wireless network, an intranet, an extranet and the Internet.

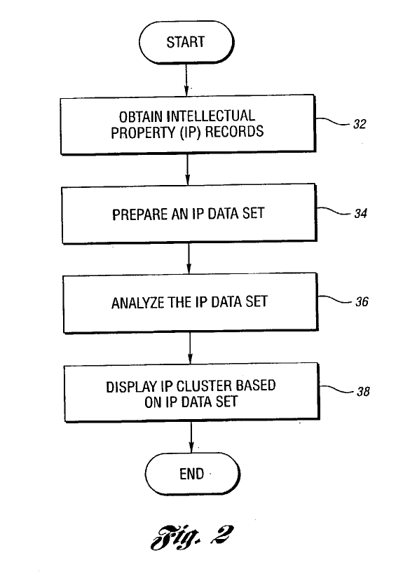

FIG. 2 is a block flow diagram illustrating a preferred methodology for implementing the present invention.

As depicted in block 32 of FIG. 2, intellectual property records are obtained. Examples of intellectual property include, but are not limited to, patents, technical reports, laboratory excerpts, or any other record of technological advances. The intellectual property records are obtained in electronic format for analysis (the analysis step is described in greater detail below). Public, internal, and/or commercial patent databases (referred to collectively as patent databases) can be utilized to obtain patents in electronic format. An example of a public patent database is the United States Patent and Trademark Office Patent Full-Text and Full-Page Image Databases available at Internet website address http://www.uspto.gov/patft/index.htm. It should be understood that other patent offices also maintain similar databases that can be used in accordance with the present invention. Internal patent databases are commonly maintained by companies having relatively large patent portfolios. An example of a commercial patent database is the Delphion Database available at Internet website address http://www.delphion.com/home, hosted by Delphion, Inc. Other forms of intellectual property, for example, laboratory notebook excerpts, that are commonly maintained in non-digital format can be converted to digital format through any appropriate method, for example, optical character recognition (OCR) methods.

In one preferred embodiment of the present invention, patent records assigned to a specific person and/or organization are obtained from patent database(s).

In another preferred embodiment of the present invention, especially suitable for competitive intelligence opportunity evaluation, patent records are obtained by any number of subject classifications, regardless of the person and/or organization to which the patents are assigned. It is fully contemplated that subject classifications can be determined by a variety of means, for example, but not limited to, patent keyword(s), patent subject classification (such as the United States or International Patent Classification), chemical indexing (such as CAS registry numbers), and citation analysis.

For example, multi-generational citation analysis can be utilized to obtain patent records. The first step of the multi-generational citation analysis is identifying a single patent or group of patents as a patent seed. An example of this technique is illustrated in co-pending U.S. patent application Ser. No. 09/621,393, entitled “Theme-Based System and Method For Classifying Documents”, filed Jul. 21, 2000, and incorporated herein by reference. The patents cited by the seed are assigned to the patent set. The patents citing the seed (otherwise referred to as first generation patent set) are also assigned to the patent set. The patents citing the first generation patent set (otherwise referred to as the second generation patent set) are also assigned to the patent set. The steps of assigning patents to the patent set based on the “patents citing” criterion may be repeated for n generations to best fit a particular implementation of the present invention. Furthermore, the patents cited by the n generation patent set (otherwise referred to as the n−1 generation patent set) are assigned to the patent set, and in turn, the patents cited by the n−1 generation patent set are assigned to the patent set. The steps of assigning patents to the patent set based on the “cited by” criterion may be repeated for n generation according to the particular implementation of the present invention. The multi-generational citation analysis can gather all cited patents, not just those patents in a direct line with the seed patent(s), from several generations of patents newer than the seed, and locate related technologies for analysis, which are not readily identifiable by keyword, organization, or other means.

Another example of a citation analysis in accordance with a preferred embodiment of the present invention is a co-citational analysis. The first step of the preferred co-citational analysis is providing a first group of patents. The first group can be grouped based on industry of assignee, assignee company, technology, etc. For example, the first group can be provided by performing a clustering application (described in more detail below). The next step includes collecting a second group of patents citing to at least patent in the first group. This step is preferably performed by using a commercial patent database, for example, Derwent Patent Citation Index. Next, for each patent member in the second group, if at least two patents cited to by the patent member are included in the first group, the at least two patents are added to a group of related patents. This step is preferably performed by the Scientific and Technical Information Network (“STN International”) using a variety of search commands (i.e., “analyze”, which extracts keywords from database records and performs statistical analyses). STN International is a cooperative venture to provide access to greater than 200 databases of scientific and technical information, some of which they produce and others, i.e., Derwent, that provide access to their own databases. As described in more detail below, the group of related patents can be used to evaluate licensing opportunities. Preferably, the citing companies (i.e., potential licensees) are identified as well.

As depicted in block 34 of FIG. 2, an intellectual property data set is prepared. With respect to patent records, it should be understood that the patent record is comprised of a plurality of data fields, i.e., title, abstract, summary of invention, claims, inventor(s), assignee(s), issue date, patent number, etc. These patent record data fields can be entered into a spreadsheet program, such as Microsoft Excel, to obtain the IP data set.

Preferably, non-patent record data fields (i.e., data not native to the patent records) can also be added to the IP data set. For example, a citation data field can be added to the IP data set. To obtain the citation data field, patent records can be evaluated for whether they have been cited to by other patents. If a patent has not been cited to by other patents, the citation data field is preferably assigned the value “NoCite”. If a patent has been cited by other patents, but only by patents from the same assignee, the citation data field is preferably assigned the value “NoCite”. The citation data field can preferably include a citations tiered value. The number of citations received by persons outside the organization or other organizations is used to assign a tiered value for the number of citations. For example, the tiers can include high (greater than 10 citation), medium (between 5 and 9 citations), or low (less than 5 citations). It should be understood that the before-mentioned tiering system with three tiers is merely illustrative and other tiering systems with more or less tiers are fully contemplated. Other non-patent data fields can include, but are not limited to, whether the technology has been donated, whether the technology is currently being used by the person or organization, the rate that applications or patents in an IP category are being examined or renewed, and a subject descriptor describing the technology. It should be understood that the non-patent data can be obtained from various sources, including, but not limited to, internal, commercial, or public databases.

Optionally, the IP data set can be subject to additional filtering prior to the analysis step (described in more detail below). This additional filtering further cleanses the IP data set to enhance the analysis and evaluation results. Such filters include, but are not limited to, filtering by assignee organizational type (e.g., limit only to U.S. or foreign corporations), or filtering to limit to only active, abandoned, or reassigned patents. Filtering may be accomplished by comparing records in the IP data set with patents in appropriate public or commercial patent databases, and further limiting the set by the desired filter parameters.

The spreadsheet is then preferably converted into a data file that includes tagged data fields to obtain the IP data set. Preferably, this conversion is accomplished through pseudo-code script. Table 1 discloses an example of pseudocode script suitable for converting data fields into a data file.

TABLE 1
Main routine

Read Data File
Open output file for writing
Initialize Pattern to be ignored (ignore)
Initialize count
Loop through each line in the file

remove characters left over from DOS (e.g., CTL M)
remove HTML code
if the line is not empty line AND the line does not

contain (ignore) string then

parse CSV
create hash
process record
increment count

end if

end Loop

End Main
parse CSV

input: line
get the record containing comma-separated value
group phrase inside the quotes
push the values into an array data structure
return an array

end parse CSV
create hash

input: Array with values for each field
built hash with field name as a key and field value as
value
return (hash)

end create hash
process record

Input : hash, output file name
Process each field and write to the output file
Separate each record with a Record key
write tagged = value per line as follow
if more than one investor then resolve multiple investors
if more than one Assignee/Applicant, then resolve
multiple values
if we have more than one date on Date field find the
earliest date
if Priority date = None use Application Date
convert dates to MM/DD/YYYY if not in this format
write all other values to the output file.

end process record

In accordance with a preferred embodiment of the present invention, patent records in the IP data set that have been cited by patents from another assignee are earmarked to be evaluated for licensing opportunities, hereafter referred to as the licensing set. Patent records in the licensing set are also preferably analyzed and evaluated for infringement opportunities, hereafter referred as the infringement set. Preferably, all obtained patent records in the data set are considered for possible donation, hereafter referred to as the donation set. Earmarking a patent or group of patents for donation or licensing can create a flag for follow-up by the IP staff or retained counsel. In follow-up, the IP owner can evaluate the business and legal implication of any cause of concern. Additionally, all obtained patent records of the IP data set can be considered for competitive intelligence evaluation, hereinafter referred to as the competitive intelligence set. It should be understood that IP data sets can be combined, separated, or rearranged to best fit a particular implementation of the present invention.

As depicted in block 36 of FIG. 2, the IP data set is analyzed. The IP data set is preferably analyzed to cluster IP records, i.e., patent records, according to technology similarity. It is fully contemplated that this clustering may be conducted with a wide range of tools, including data visualization applications, data mining applications, clustering applications, etc. These analyses create an IP cluster of the technologies clustering similar technologies together. For example, in one application, the IP data set may be transformed into n-dimensional vectors, and then grouped with patent records in the n-dimensional space.

As depicted in block 38, the IP cluster can be displayed, preferably by data visualization techniques. Data visualization refers to any method of graphically displaying the analyzed IP data set. Preferably, Cartia ThemeScape is utilized for data visualization in accordance with the present invention. ThemeScape can create IP clusters to cluster patents according to technology similarity and map the IP clusters to resemble geographic contour maps. The ThemeScape application utilizes self-organizing maps (SOMs) to display IP clusters. A SOM refers to a neural network technique that uses vectors as inputs and outputs locations on a grid. It is fully contemplated that other clustering algorithms may be utilized, such as k-means or hierarchical.

The IP cluster maps produced by data visualization applications provide several advantages. First, they depict clusters of related technology that are independent of the business group that created the patent. As a corollary, similar patents from different departments within a multi-department company can be grouped together. Second, the maps are user interactive, and the IP data set associated with the maps can be filtered and extracted based on user criteria. Third, mapping of merged data (internal patent information merged with textual data unique to commercial databases) allows visualization of patterns not discernable by mapping unmerged data.

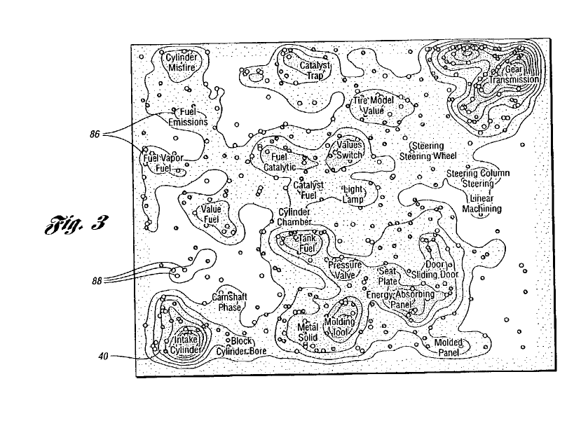

FIG. 3 is an IP cluster map generated by data visualization software (ThemeScape) from an IP data set for evaluating licensing/infringement opportunities in accordance with one embodiment of the present invention. Various technology clusters 86 (or simply clusters), i.e., “fuel emissions” and “fuel vapor fuel”, are depicted in spacial relationship with each other on the IP cluster map. Patent data points 88 are plotted based on descriptions of the technology embodied in the patent records. Groupings 90 of patent data points 88 are typically located within or about a technology cluster 86. For example, a grouping 90 is depicted within the technology cluster 86 for “intake cylinders”. This IP cluster map can be used to evaluate intellectual property opportunities in accordance with the present invention (described in more detail below).

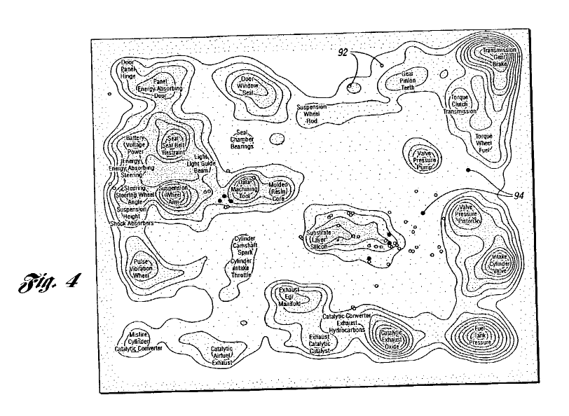

FIG. 4 is an IP cluster map generated by data visualization software (ThemeScape) from an IP data set for evaluating donation opportunities in accordance with one embodiment of the present invention. The IP cluster map of FIG. 4 illustrates that a plurality of types of patent data points can be depicted on the same IP cluster map. For example, “kept” patent data points 92 (open circles) can be plotted along with donated patent data points 94 (pin dots). It should be understood that “kept” patents refer to those retained by an organization. This type of IP cluster map is useful in identifying intellectual property opportunities in accordance with the present invention (described in more detail below).

IP opportunities are preferably evaluated based on the IP clusters produced by analyzing the IP data set(s). It should be understood that the IP data set can be comprised of a licensing set, a donation set, an infringement set, or a competitive intelligence set or combination thereof. The plurality of IP clusters are preferably mapped using a data visualization application to obtain an IP cluster map. IP opportunities can include, but are not limited to, licensing, donation, infringement, and competitive intelligence opportunities.

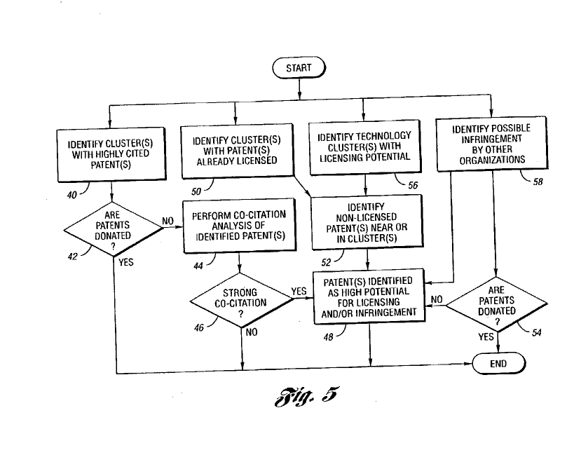

FIG. 5 is a block flow diagram illustrating a preferred methodology for evaluating licensing/infringement opportunities. Although the preferred methodology in FIG. 5 involves evaluating licensing and infringement opportunities in combination, it is understood that these opportunities can be evaluated individually as well. Preferably, a licensing/infringement set can be subjected to at least four methods of evaluation in combination or individually based on the plurality of IP clusters. Preferably, the IP clusters are mapped to obtain a licensing/infringement cluster map for use with the methods of evaluation.

As depicted in block 40, the first method includes identifying cluster(s) containing highly cited patent(s) (i.e., more than 10 citations from outside the organization). Preferably, when a cluster containing highly cited patents is identified, other nearby technologically similar patents which are not highly cited may be evaluated. As depicted in decision block 42, if the patent(s) have been donated, the investigation into licensing/infringement opportunities ends. If the patents have not been donated, as depicted in block 44, a co-citation analysis can be performed on the patent(s) to determine if outside parties have identified elements of the cluster as a group of strongly related technologies (i.e., a co-citation group is located). As depicted in decision block 46, if a plurality of patents has been recognized by other assignees, the plurality of patents are identified as high potential for licensing, as depicted in block 48. Preferably, the target companies (i.e., other assignees) are identified, as well.

As depicted in block 50, the second method includes identifying cluster(s) containing patent(s) already licensed. Other non-licensed patent(s) located near a cluster of similar technologies are also evaluated as additional licensing candidates, as depicted in block 52. As depicted in decision block 54, if the patent(s) identified in blocks 50 and 52 have been donated, the investigation into licensing/infringement opportunities ends. If the patent(s) have not been donated, the patent(s) are identified as high potential group for licensing, as depicted in block 48. Preferably, the target companies (i.e., licensees) are identified, as well.

As depicted in block 56, the third method includes identifying technology cluster(s) with licensing potential. Non-licensed patents in or near these technology cluster(s) are preferably identified, as depicted in block 52. As depicted in decision block 54, if the patent(s) identified in blocks 52 and 56 have been donated, the investigation into licensing/infringement opportunities ends. If the patent(s) have not been donated, the patent(s) are identified as high potential group for licensing, as depicted in block 48. Target companies are also preferably identified.

As depicted in block 58, the fourth method includes identifying possible infringement by other organizations. This method can include evaluating the licensing/infringement set using a combination of IP cluster map(s) and co-citation analysis. The resulting evaluation can be used to identify companies that may be infringing upon another company's patents, as depicted in block 48.

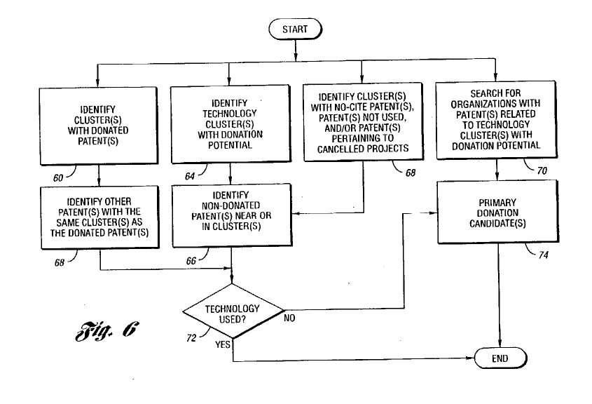

FIG. 6 is a block flow diagram illustrating a preferred methodology for evaluating donation opportunities. Preferably, a donation set can be subjected to at least four methods of evaluation in combination or individually based on the plurality of IP clusters. Preferably, the IP clusters are mapped to obtain a donation cluster map for use with the methods of evaluation.

As depicted in block 60, the first method includes identifying clusters containing donated patents. Other patents within the same cluster(s) as the donated patent(s) are identified, as depicted in block 62. As depicted in block 64, the second method includes identifying technology cluster(s) with donation potential. Non-donated patent(s) in or near these technology cluster(s) are preferably identified, as depicted in block 66. As depicted in block 68, the third method includes identifying cluster(s) containing no-cite patent(s), patent(s) not used by the company, and/or patent(s) pertaining to cancelled projects. By identifying these clusters (and identifying non-donated patent(s) near or in these cluster(s), as depicted in block 66), a company can identify patents that are ripe for donation or abandonment.

As depicted in block 72, if the patent(s) uncovered using any of the three methods described above comprises technology used by the company, the donation opportunity determination ends. The theory behind ending the assessment is technology that is utilized by a company is not ready for donation. If the patent does not comprise “use” technology, the patent(s) are considered as primary candidate(s) for donation, as depicted in block 74.

As depicted in block 70, the fourth method includes identifying organizations with patent(s) related to technology cluster(s) with donation potential. This step preferably includes adding other patent records to the donation set, i.e., patents of a given second organization or a given technology, in the same map as the first organization's, in order to perform the comparison. The organizations can be donees or synergistic donation partners. This type of analysis can be used to bundle technology for donation. Bundling can result in non-linear value increases as the size of the bundle increases.

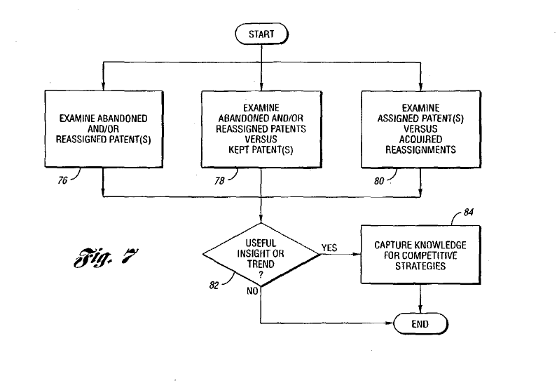

FIG. 7 is a block flow diagram illustrating a preferred methodology for evaluating competitive intelligence opportunities. Preferably, a competitive intelligence set can be subjected to at least three methods of evaluation in combination or individually based on the plurality of IP clusters. Preferably, the IP clusters are mapped to obtain a competitive intelligence cluster map for use with method of evaluation.

As depicted in block 76, the first method includes examining abandoned and/or reassigned patents. This examination can include a IP cluster map of a company's patents, a competitor's patents, or combination thereof. If a company's patents are mapped with a competitor's, an IP cluster map comparable to FIG. 4 can be used to identify these different types (i.e., company/competition) of patents on the same IP cluster map. It should also be understood that related technology fields can be mapped as well. These types of maps apply to the second and third method as well. As depicted in block 78, the second method includes abandoned and/or assigned patent(s) versus its kept patent(s). As depicted in block 80, the third method includes examining assigned patents versus acquired reassignment(s). As depicted in block 82, the examination methods of blocks 76, 78 and 80 can be used individually or in combination to be evaluated for useful trends or insights. Useful trends include, but are not limited to: (1) identification of emerging technologies, (2) strategic patenting (i.e., clustering and/or bracketing), (3) patenting trends (i.e., increased or decreased patenting in a technology field), and (4) technologies that are no longer pursued for patent prosecution. If a useful trend or insight is identified, the knowledge related to this trend/insight is captured for competitive intelligence strategies, as depicted in block 84. If a useful trend/insight is not identified, the competitive intelligence determination ends.

While the best mode for carrying out the invention has been described in detail, those familiar with the art to which this invention relates will recognize various alternative designs and embodiments for practicing the invention as defined by the following claims.

1. A computer-implemented method for evaluating intellectual property comprising:
obtaining a plurality of intellectual property (IP) records;
preparing an IP data set based on the plurality of IP records;
analyzing the IP data set to obtain an at least one IP cluster; and
displaying the at least one IP cluster to allow a user to evaluate IP opportunities for the IP data set.

2. The computer-implemented method of claim 1 wherein the IP records are comprised of patent records.

3. The computer-implemented method of claim 2 wherein the IP data set includes an at least one non-patent data field for each patent record.

4. The computer-implemented method of claim 1 wherein the analyzing step utilizes a self-organizing map technique.

5. The computer-implemented method of claim 1 wherein the displaying step is comprised of graphically displaying the at least one IP cluster utilizing data visualization software.

6. The computer-implemented method of claim 5 wherein the IP data set is a licensing set and the evaluating step is comprised of evaluating the licensing set for licensing opportunities based on the at least one IP cluster.

7. The computer-implemented method of claim 5 wherein the IP data set is a donation set and the evaluating step is comprised of evaluating the donation set for donation opportunities based on the at least one IP cluster.

8. The computer-implemented method of claim 5 wherein the IP data set is an infringement set and the evaluating step is comprised of evaluating the infringement set for infringement opportunities based on the at least one IP cluster.

9. The computer-implemented method of claim 5 wherein the IP data set is a competitive intelligence set and the evaluating step is comprised of evaluating the competitive intelligence set for competitive intelligence opportunities based on the at least one IP cluster.

10. A computer-implemented system for evaluating intellectual property comprising at least one computer wherein the at least one computer is configured to:
obtain a plurality of intellectual property (IP) records;
prepare an IP data set based on the plurality of IP records;
analyze the IP data set to obtain an at least one IP cluster; and
display the at least one IP cluster to allow a user to evaluate IP opportunities for the IP data set.

11. The computer-implemented system of claim 10 wherein the IP records are comprised of patent records.

12. The computer-implemented system of claim 11 wherein the IP data set includes an at least one non-patent data field for each patent record.

13. The computer-implemented system of claim 10 wherein the at least one computer is additionally configured to analyze the IP data set based on a self-organizing map technique.

14. The computer-implemented system of claim 10 wherein the at least one computer is configured to graphically display the at least one IP cluster by utilizing data visualization software.

15. The computer-implemented system of claim 14 wherein the IP data set is a licensing set and the at least one computer is configured to evaluate licensing opportunities based on the at least one IP cluster.

16. The computer-implemented system of claim 14 wherein the IP data set is a donation set and the at least one computer is configured to evaluate donation opportunities based on the at least one IP cluster.

17. The computer-implemented system of claim 14 wherein the IP data set is an infringement set and the at least one computer is configured to evaluate infringement opportunities based on the at least one IP cluster.

18. The computer-implemented system of claim 14 wherein the IP data set is a competitive intelligence set and the at least one computer is configured to evaluate competitive intelligence opportunities based on the at least one IP cluster.

19. A computer-implemented system for evaluating intellectual property comprising:
a means for obtaining a plurality of intellectual property (IP) records;
a means for preparing an IP data set based on a plurality of IP records;
a means for analyzing the IP data set to obtain an at least one IP cluster; and
a means for displaying the at least one IP cluster to allow a user to evaluate IP opportunities for the IP data set.

20. The computer-implemented system of claim 19 wherein the IP records are comprised of patent records.

21. The computer-implemented system of claim 20 wherein the IP data set includes an at least one non-patent data field for each patent record.

22. The computer-implemented system of claim 19 wherein the means for analyzing is based on a self-organizing map technique.

23. The computer-implemented system of claim 19 wherein the means for displaying is comprised of data visualization software.

24. A method for identifying a group of related patents comprising:
providing a first group of patents;
collecting a second group of patents citing to at least one patent in the first group; and
for each patent member in the second group, if at least two patents cited to by the patent member are included in the first group, add the at least two patents to a group of related patents,
wherein the group of related patents are identified for licensing opportunities.

25. The method of claim 24 wherein the adding step is comprised of:
for each patent member in the second group, if at least three patents cited to by the patent are included in the first group, add the at least three patents to the group of related patents.

26. The method of claim 24 wherein the first group of patents are assigned to one company.

27. The method of claim 24 wherein the first group of patents are grouped based on technological similarity.
